(19) United States
(12) Patent Application Publication
(10) Pub. No.: US 2008/0219567 A1
(43) Pub. Date: Sep. 11, 2008

(54) Tomosynthesis imaging data compression system and method

(75) Inventors: Bernhard Erich Hermann Claus, Niskayuna, NY (US); Frederick Wilson Wheeler, Niskayuna, NY (US); Baojun Li, Waukesha, WI (US); Razvan Gabriel Iordache, Paris (FR)

Correspondence Address: GENERAL ELECTRIC COMPANY (PCPI);C/O FLETCHER YODER, P. O. BOX 692289, HOUSTON, TX, 77269-2289, US

(73) Assignee: General Electric Company

(21) Appl. No.: 11/714,969

(22) Filed: Mar. 7, 2007

(51) Int. Cl. G06K 9/36

(52) U.S. Cl. 382/232

(57) ABSTRACT

A technique and system are provided for compression of tomosynthesis imaging data. In an embodiment of the present technique, tomosynthesis imaging data may be compressed by processing a stack of tomosynthesis images such that differences between some or all of the images or estimates of the images are encoded. In another embodiment of the present technique, tomosynthesis imaging data may be compressed by differentially compressing two or more regions within the one or more tomosynthesis imaging datasets. In addition, there is provided tangible, machine readable media, with code executable to perform the acts of obtaining one or more tomosynthesis imaging datasets and compressing the one or more tomosynthesis imaging datasets using one or more compression algorithms.

### BACKGROUND

The present invention relates generally to the field of medical imaging, and more specifically to the field of tomosynthesis. In particular, the present invention relates to the compression of data acquired during tomosynthesis.

Tomographic imaging technologies are of increasing importance in medical diagnosis, allowing physicians and radiologists to obtain three-dimensional representations of selected organs or tissues of a patient non-invasively. Tomosynthesis is a variation of conventional planar tomography in which a limited number of radiographic projections are acquired at different angles relative to the patient. In tomosynthesis, an X-ray source produces a fan or cone-shaped X-ray beam that is collimated and passes through the patient to then be detected by a set of detector elements. The detector elements produce a signal based on the attenuation of the X-ray beams. The signals may be processed to produce a radiographic projection, including generally the line integrals of the attenuation coefficients of the object along the ray path. The source, the patient, or the detector are then moved relative to one another for the next exposure, typically by moving the X-ray source, so that each projection is acquired at a different angle.

By using reconstruction techniques, such as filtered backprojection, the set of acquired projections may then be reconstructed to produce diagnostically useful three-dimensional images. Because the three-dimensional information is obtained digitally during tomosynthesis, the image can be reconstructed in whatever viewing plane the operator selects. Typically, a set of slices representative of some volume of interest of the imaged object is reconstructed, where each slice is a reconstructed image representative of structures in a plane that is parallel to the detector plane, and each slice corresponds to a different distance of the plane from the detector plane. Depending on the size of the volume, this three-dimensional dataset may contain hundreds of slices. As such, the three-dimensional dataset may be very large, creating problems in data storage and transmission.

Large image datasets are typically stored in digital form in a picture archive communications system or PACS, or some other digital storage medium. For viewing, the images of interest are typically then loaded from the PACS to a diagnostic workstation. Large datasets require significant bandwidth and result in significant delay in the transfer from the PACS archive to the diagnostic workstation. Therefore, there is a need for an improved technique for storing and transmitting tomosynthesis datasets.

### BRIEF DESCRIPTION

There is provided a method for processing tomosynthesis imaging data including obtaining one or more tomosynthesis imaging datasets and compressing the one or more tomosynthesis imaging datasets using one or more compression algorithms.

There is further provided one or more tangible, machine-readable media with code executable to perform the acts of obtaining one or more tomosynthesis imaging datasets and compressing the one or more tomosynthesis imaging datasets using one or more compression algorithms.

There is further provided a tomosynthesis imaging data processing system including a computer capable of being operably coupled to at least one of a tomosynthesis image acquisition system or a tomosynthesis image storage system, the computer system being configured to obtain one or more tomosynthesis imaging datasets and compress the one or more tomosynthesis imaging datasets using one or more compression algorithms.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical view of an exemplary imaging system in the form of a tomosynthesis imaging system for use in producing processed images in accordance with aspects of the present technique;

FIG. 2 is a diagrammatical view of a physical implementation of the tomosynthesis system of FIG. 1;

FIG. 3 is a perspective view of a three-dimensional object represented as slices;

FIGS. 4-5 are views of individual slices;

FIG. 6 is a view of the overlap between the slices of FIGS. 4 and 5;

FIG. 7 is a side view of a stack of slices;

FIGS. 8-12 are flow charts of exemplary compression processes according to embodiments of the present technique.

### DETAILED DESCRIPTION

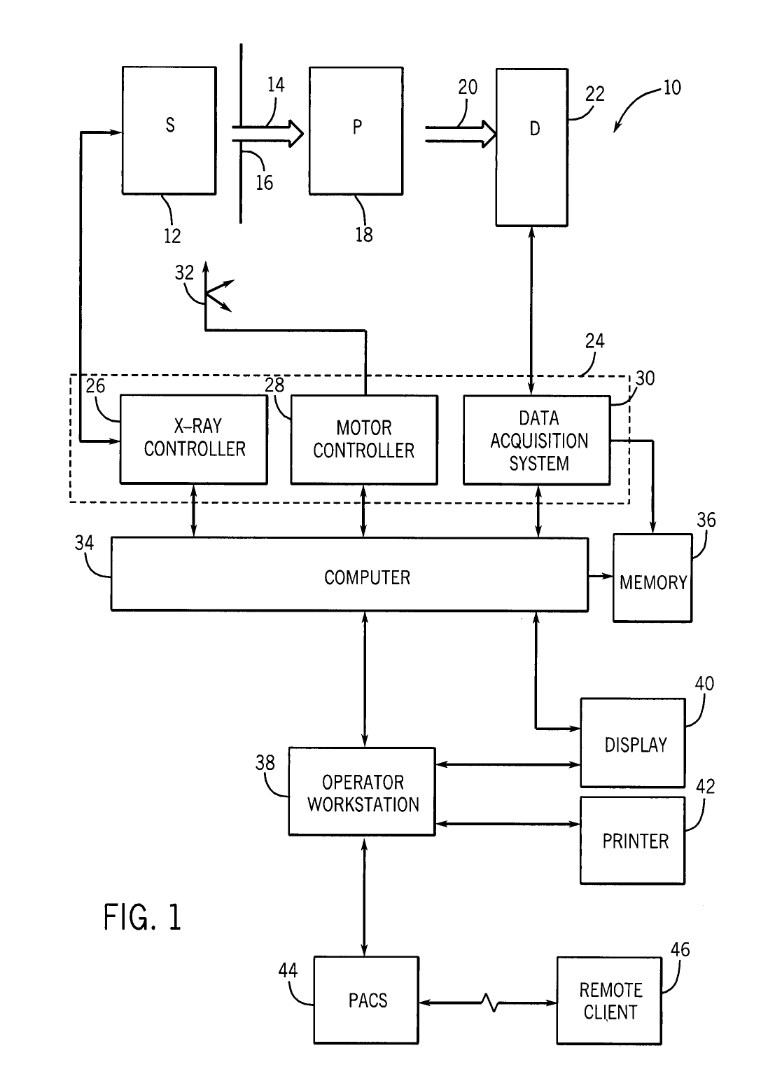

FIG. 1 is a diagrammatical representation of an exemplary tomosynthesis system, designated generally by the reference numeral 10, for acquiring, processing and displaying tomosynthesis images, including images of various slices or slabs through a subject of interest in accordance with the present techniques. In the embodiment illustrated in FIG. 1, tomosynthesis system 10 includes a source 12 of X-ray radiation which is movable generally in a plane, or in three dimensions. In the exemplary embodiment, the X-ray source 12 typically includes an X-ray tube and associated support and filtering components.

A stream of radiation 14 is emitted by source 12 and passes into a region of a subject, such as a human patient 18. A collimator 16 serves to define the size and shape of the X-ray beam 14 that emerges from the X-ray source toward the subject. A portion of the radiation 20 passes through and around the subject, and impacts a detector array, represented generally by reference numeral 22. Detector elements of the array produce electrical signals that represent the intensity of the incident X-ray beam. These signals are acquired and processed to reconstruct an image of the features within the subject.

Source 12 is controlled by a system controller 24 which furnishes both power and control signals for tomosynthesis examination sequences, including position of the source 12 relative to the subject 18 and detector 22. Moreover, detector 22 is coupled to the system controller 24 which commands acquisition of the signals generated by the detector 22. The system controller 22 may also execute various signal processing and filtration functions, such as for initial adjustment of dynamic ranges, interleaving of digital image data, and so forth. In general, the system controller 24 commands operation of the imaging system to execute examination protocols and to process acquired data. In the present context, the system controller 24 also includes signal processing circuitry, typically based upon a general purpose or application-specific digital computer, associated memory circuitry for storing programs and routines executed by the computer, as well as configuration parameters and image data, interface circuits, and so forth.

In the embodiment illustrated in Fig.1, the system controller 24 includes an X-ray controller 26 which regulates generation of X-rays by the source 12. In particular, the X-ray controller 26 is configured to provide power and timing signals to the X-ray source 12. A motor controller 28 serves to control movement of a positional subsystem 32 that regulates the position and orientation of the source 12 with respect to the subject 18 and detector 22. The positional subsystem may also cause movement of the detector 22, or even the patient 18, rather than or in addition to the source 12. It should be noted that in certain configurations, the positional subsystem 32 may be eliminated, particularly where multiple addressable sources 12 are provided. In such configurations, projections may be attained through the triggering of different sources of X-ray radiation positioned differentially relative to the patient 18 and/or source 22. Finally, in the illustration of FIG. 1, detector 22 is coupled to a data acquisition system 30 that receives data collected by read-out electronics of the detector 22. The data acquisition system 30 typically receives sampled analog signals from the detector and converts the signals to digital signals for subsequent processing by a computer 34. Such conversion, and indeed any preprocessing, may actually be performed to some degree within the detector assembly itself.

Computer 34 is typically coupled to the system controller 24. Data collected by the data acquisition system 30 is transmitted to the computer 34 and, moreover, to a memory device 36. Any suitable type of memory device, and indeed of a computer, may be adapted to the present technique, particularly processors and memory devices adapted to process and store large amounts of data produced by the system. Moreover, computer 34 is configured to receive commands and scanning parameters from an operator via an operator workstation 38, typically equipped with a keyboard, mouse, or other input devices. An operator may control the system via these devices, and launch examinations for acquiring image data. Moreover, computer 34 is adapted to perform reconstruction of the image data as discussed in greater detail below. Where desired, other computers or workstations may perform some or all of the functions of the present technique, including post-processing of image data accessed from memory device 36 or another memory device at the imaging system location or remote from that location.

In the diagrammatical illustration of FIG. 1, a display 40 is coupled to the operator workstation 38 for viewing reconstructed images and for controlling imaging. Additionally, the image may also be printed or otherwise output in a hardcopy form via a printer 42. The operator workstation, and indeed the overall system may be coupled to large image data storage devices, such as a picture archiving and communication system (PACS) 44. The PACS 44 may be coupled to a remote client, as illustrated at reference numeral 46, such as for requesting and transmitting images and image data for remote viewing and processing as described herein. It should be further noted that the computer 34 and operator workstation 38 may be coupled to other output devices which may include standard or special-purpose computer monitors, computers and associated processing circuitry. One or more operator workstations 38 may be further linked in the system for outputting system parameters, requesting examinations, viewing images, and so forth. In general, displays, printers, workstations and similar devices supplied within the system may be local to the data acquisition components or remote from these components, such as elsewhere within an institution or in an entirely different location, being linked to the imaging system by any suitable network, such as the Internet, virtual private networks, local area networks, and so forth.

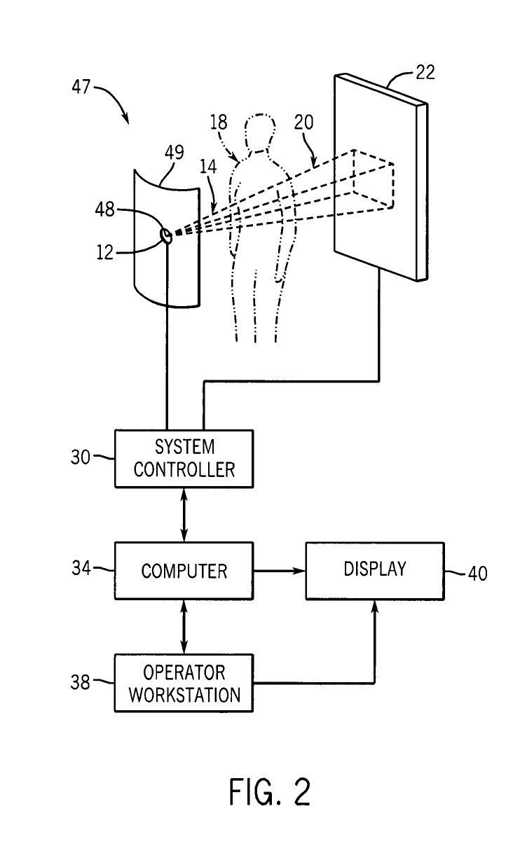

Referring generally to FIG. 2, an exemplary implementation of a tomosynthesis imaging system of the type discussed with respect to FIG. 1 is illustrated. As shown in FIG. 2, an imaging scanner 47 generally permits interposition of a subject 18 between the source 12 and detector 22. Although a space is shown between the subject and detector 22 in FIG. 2, in practice, the subject may be positioned directly before or against the imaging plane of the detector 22. The detector 22 may, moreover, vary in size and configuration. The X-ray source 12 is illustrated as being positioned at a source location or position 48 for generating one or a series of projections. In general, the source is movable to permit multiple such projections to be attained in an imaging sequence. In the illustration of FIG. 2, a curved source surface 49 is defined by the array of positions available to source 12. This curved source surface 49 may be representative of, for example, an X-ray tube attached to a gantry arm which rotates around a pivot point in order to acquire projections from different views. The source surface 49 may, of course, be replaced by other three-dimensional trajectories for a movable source 12. Alternatively, two-dimensional or three-dimensional layouts and configurations may be defined for multiple sources which may or may not be independently movable.

In typical operation, X-ray source 12 projects an X-ray beam from its focal point toward detector 22. A portion of the beam 14 that traverses the subject 18, results in attenuated X-rays 20 which impact detector 22. This radiation is thus attenuated or absorbed by the internal features of the subject, such as internal anatomies in the case of medical imaging. The detector 22 is formed by a plurality of detector elements generally corresponding to discrete picture elements or pixels in the resulting image data. The individual pixel electronics detect the intensity of the radiation impacting each pixel location and produce output signals representative of the radiation. In an exemplary embodiment, the detector consists of an array of 2048×2048 pixels. Other detector configurations and resolutions are, of course, possible. Each detector element at each pixel location produces an analog signal representative of the impending radiation that is converted to a digital value for processing.

Source 12 is moved and triggered, or offset distributed sources are similarly triggered, to produce a plurality of projections or images from different source locations. These projections are produced at different view angles and the resulting data is collected by the imaging system. In an exemplary embodiment involving breast imaging, the gantry or arm to which source 12 is attached has a pivot point located 22.4 cm above the detector 22. The distance from the focal point of source 12 to the pivot point of the gantry or arm is 44.0 cm. The considered angular range of the gantry with respect to the pivot point is from −25 to 25 degrees, where 0 degrees corresponds to the vertical position of the gantry arm (i.e., the position where the center ray of the X-ray cone beam is perpendicular to the detector plane). With this system, typically 11 projection radiographs are acquired, each 5 degrees apart covering the full angular range of the gantry, although the number of images and their angular separation may vary. This set of projection radiographs constitutes the tomosynthesis projection dataset.

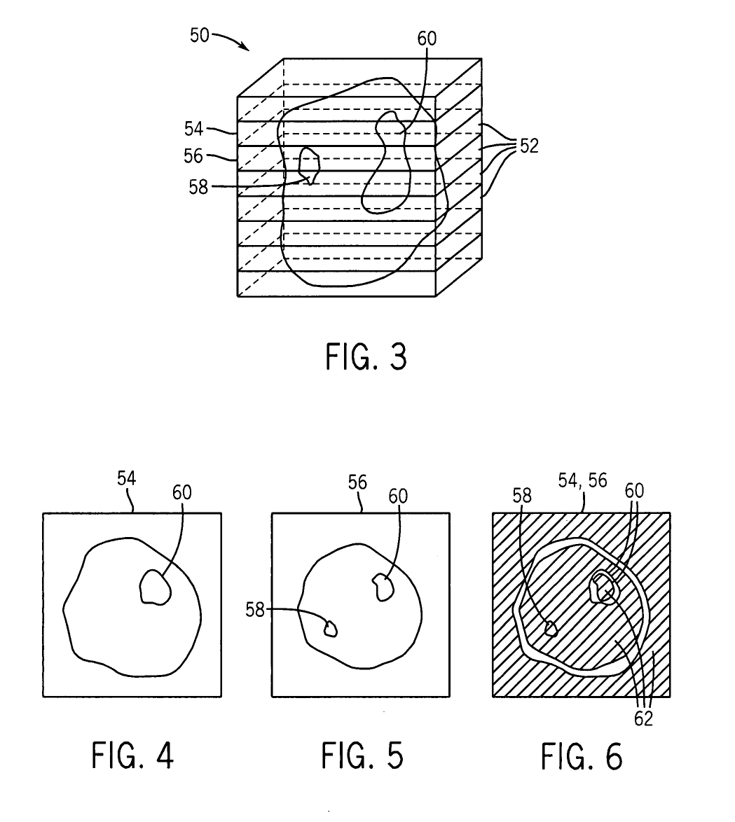

Either directly at the imaging system, or in a post-processing system, data collected by the system is manipulated to reconstruct a three-dimensional representation 50 of the volume imaged, as illustrated in FIG. 3. For example, in a process referred to as backprojection, the system performs mathematical operations designed to compute the spatial distribution of the X-ray attenuation within the imaged object. This information is then used to construct slices 52. These slices 52 are generally parallel to the detector 22 plane, although other arrangements are possible as well. For example, a reconstructed dataset may be reformatted such that it consists of vertical slices rather than the horizontal slices 52 as illustrated in FIG. 3. In an exemplary embodiment, the spacing between slices 52 may be 1 mm or less. This means that, in an exemplary mammography implementation, a tomosynthesis dataset for a breast with a compressed breast thickness of 5 cm may consist of 50 or more slices 52, each with the resolution of a single mammogram. For a thicker breast, more slices 52 may be reconstructed. The slices 52 may be essentially stacked together to create the three-dimensional representation 50 of an imaged object.

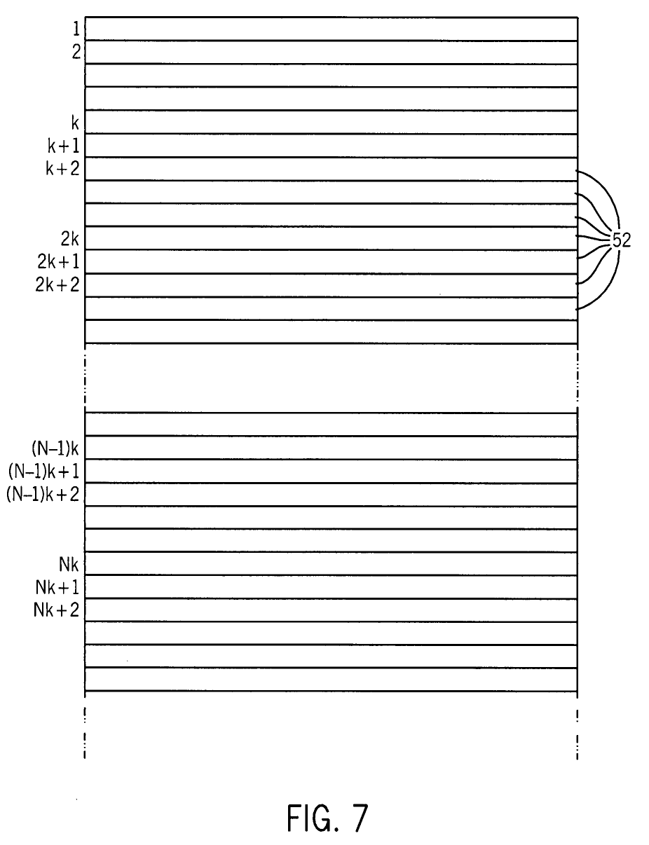

In order to preserve small structures 58 within the three-dimensional representation 50 with a high degree of accuracy, the representation 50 may be composed of many slices 52 spaced very close together. The close spacing of the slices 52 may imply that larger structures 60 in the three-dimensional representation 50 are visible in numerous slices 52. As such, there may be redundant data from one slice 52 to the next. Generally speaking, the smaller the distance between two slices 52, the higher their degree of similarity or redundancy. For example, adjacent slices 54 (FIG. 4) and 56 (FIG. 5) may contain a great deal of similar data with only minor differences. In addition, the vertical resolution of tomosynthesis imaging may be limited by the angular range of the acquired projection images, therefore lower spatial frequencies may have a higher degree of similarity between adjacent slices.

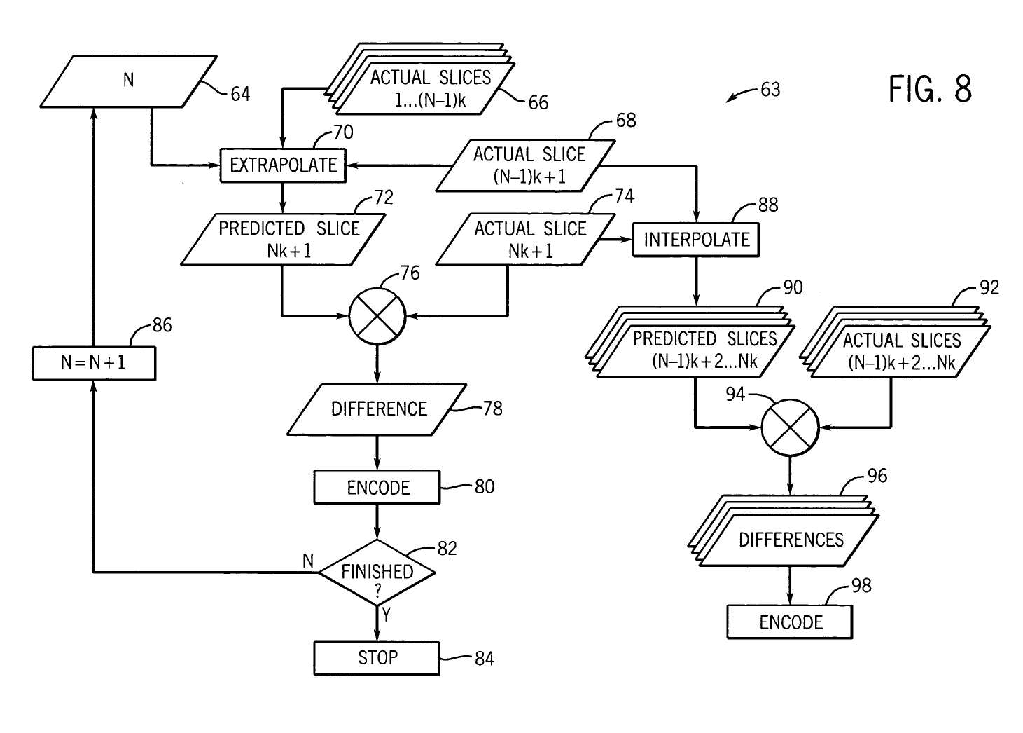

FIGS. 4-6 illustrate the similarities between adjacent slices 54 and 56. In the illustrated example, slice 54 (FIG. 4) is adjacent to slice 56 (FIG. 5). The larger structure 60 may be visible in both slices 54 and 56, whereas the smaller structure 58 may appear only in slice 56. It should be understood by one skilled in the art that this illustration is greatly simplified, as in reconstruction even a small structure 58 may be visible in adjacent slices or even appear as an artifact in all slices of a reconstructed volume. In FIG. 6, the shaded regions 62 illustrate areas of data overlap between the adjacent slices 54 and 56. This similarity may be used to compress the sequence of slices 52 to facilitate storage and transfer of the dataset.

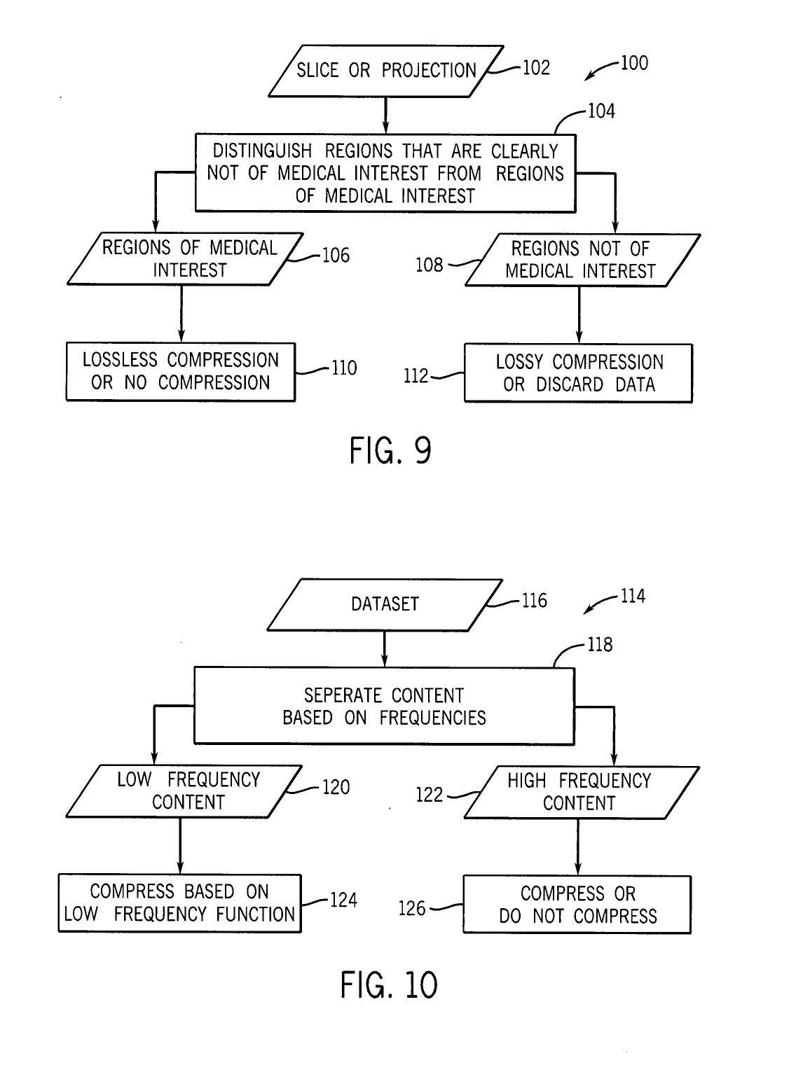

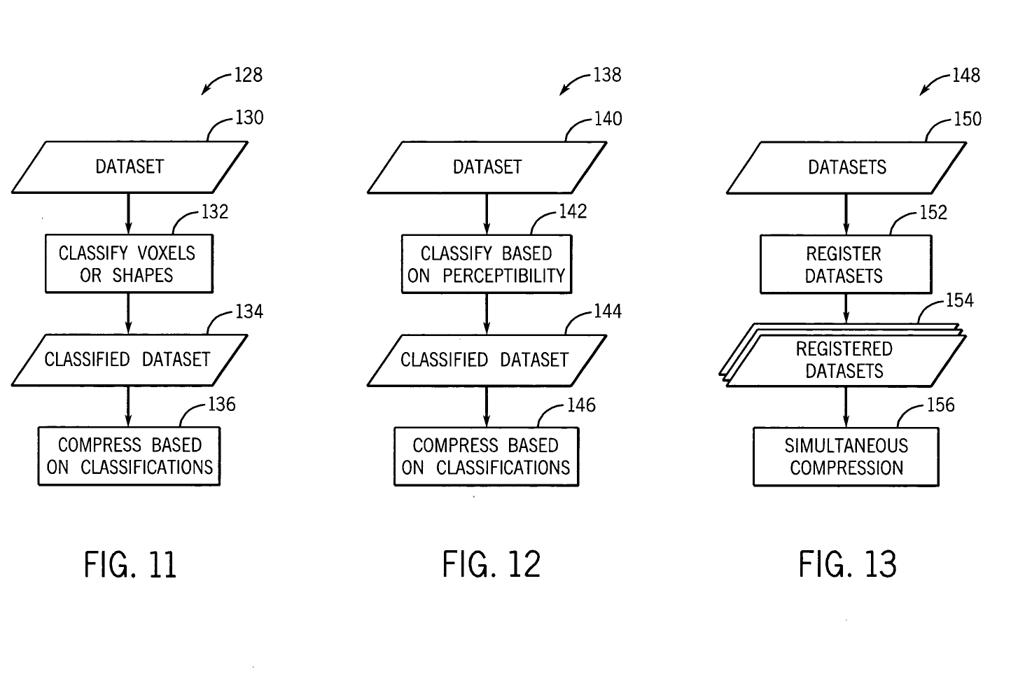

In one embodiment of the present technique, the slices 52 may be thought of as stacked, and may be numbered as illustrated in FIG. 7. In this illustration, “k” represents the number of slices encoded in each iteration of an exemplary compression process 63, described below in reference to FIG. 8. The variable “N” is a positive integer which, when considered with “k,” represents the location of a given slice in the stack.

FIG. 8 illustrates an exemplary compression process 63 in which an image compression algorithm may predict and/or interpolate some slices from slices that were previously encoded during the compression process 63. For a given value of “N” (Block 64), slices 1 through (N−1)k (Block 66) and (N−1)k+1 (Block 68) are used to extrapolate (Block 70) a predicted slice Nk+1 (Block 72). This extrapolation (Block 70) may include any suitable extrapolation method. The predicted slice Nk+1 (Block 72) is compared to the actual slice Nk+1 (Block 74). The difference between the actual and predicted images is calculated (Block 76), and this difference image (Block 78) is encoded (Block 80).

In a parallel sequence, slices (N−1)k+1 (Block 68) and Nk+1 (Block 74) are used to interpolate slices (N−1)k+2 through Nk (Block 88). In one embodiment of the present technique, this interpolation method may be a simple linear interpolation. In another embodiment, the interpolation method may use actual image content from slices (N−1)k+2 through Nk and may include a registration step that geometrically maps corresponding structures to each other with the help of a rigid or non-rigid transformation. By using actual image content in the interpolation, the image quality in the interpolated images may be improved, thus reducing the amount of information in the difference images. The predicted slices (N−1)k+2 through Nk (Block 90) are then compared to the actual slices (N−1)k+2 through Nk (Block 92). The difference between each actual and predicted image is calculated (Block 94), and the resulting difference images (Block 96) are encoded (Block 98).

If there are still slices 52 which need to be encoded, the compression process continues at N=N+1 (Block 86). It should be noted that the order in which the slices are compressed may impact the order in which they are later decompressed. In one embodiment, the top-down order as indicated in FIG. 7 may be used. In another embodiment, a bottom-up order may be used, or the dataset may be arranged in slices that are oriented perpendicularly to the slices as described here. It may be advantageous to compress the slices such that upon decompression the images that would be viewed first in a typical review sequence of the tomosynthesis dataset are also decompressed first. In this embodiment of the present technique, review of the images may begin before all of the images are decompressed, thus reducing the wait time for decompression. In addition, this process may be applied only to one or more portions of the stack of slices 52. In another embodiment of the present technique, some of the images used in the encoding may not be individual slices of the dataset, but for example images obtained as an average, weighted average, mean, median, or mode of certain subsets of slices of the dataset (e.g., “thick slices”). In one embodiment, the average, mean, median, or mode of all slices in the dataset may be used as a reference image in the compression algorithm. Other images formed from the full three-dimensional dataset, or subsets of slices or subregions thereof, may also be used.

In an exemplary embodiment, the compression process 63 begins at N=1 (Block 64). In this example, (N−1)k+1=1, therefore slice k+1 is predicted from only slice 1 (Blocks 66, 68) based on a suitable extrapolation method (Block 70). This predicted slice k+1 (Block 72) is compared (Block 76) to the actual slice k+1 (Block 74), and the difference (Block 78) is encoded (Block 80). In addition, slices 2 through k are interpolated (Block 88) from slices 1 (Block 68) and k+1 (Block 74). These predicted slices (Block 90) are also compared (Block 94) to the actual slices 2 through k (Block 92), and the differences (Block 96) are encoded (Block 98). If there are still more slices to encode, the process continues (Block 82) with N=2 (Block 86). In this iteration, slice 2k+1 is predicted from slices 1 through k+1 (Blocks 66, 68) based on the extrapolation method (Block 70). Once again, the predicted slice (Block 72) is compared (Block 76) to the actual slice (Block 74) and the difference (Block 78) is encoded (Block 80). Slices k+2 through 2k are interpolated (Block 88) from slices k+1 (Block 68) and 2k+1 (Block 74). These predicted slices (Block 90) are then compared (Block 94) to the actual slices k+2 through 2k (Block 92) and the differences (Block 96) are encoded (Block 98). This iterative process may continue until all of the slices have been encoded.

FIG. 9 illustrates compression process 100, another embodiment of the present technique. In a given three-dimensional imaged volume of a patient, there is generally some data that is not medically relevant, such as air or background. The tomosynthesis dataset may be compressed by separating this data from the data which is medically relevant and treating the two types of data differently. In the present technique, for each slice or projection 102 the regions of medical interest 106 are distinguished from the regions clearly not of medical interest 108 in a step 104. Once these regions are separated, the regions of medical interest 106 may be compressed using a lossless compression method or may not be compressed (Block 110). In contrast, the regions not of medical interest 108 may be compressed using a lossy compression method or may be discarded altogether (Block 112). Lossy compression may include, for example, discarding fine-scale details which would not be necessary to display in regions of little or no medical interest 108. In the resulting compressed image, the compression characteristics vary locally according to the compression technique employed in a region. As such, the degree of fidelity to the original, uncompressed image varies locally, where the compressed regions of medical interest 106 may be close or identical in content to the original image. Conversely, the compressed regions not of medical interest 108 may differ from the content of the original image to a greater degree. The regions 106 and 108 may be determined automatically or by user interaction, as discussed below.

In one embodiment of the technique outlined in FIG. 9, the skinline of the anatomy may define the boundary between regions 106 and 108, where the region inside the skinline is of medical interest and the region outside the skinline is not of medical interest. The skinline is typically a smooth curve which can be detected automatically. Alternatively, a user may interactively outline the skinline to distinguish the regions 106 and 108. Once the boundary between regions has been established, data from inside the skinline, representing the region of medical interest 106, may be compressed using a lossless compression method or may be stored without compression (Block 110). Data from outside the skinline, representing the region not of medical interest 108, may be compressed using a lossy compression method or may be discarded altogether (Block 112). In addition, the skinline itself may be compressed as a smooth curve in a sequence of two-dimensional images or as a smooth three-dimensional surface. Compressing the skinline may involve, for example, coding a start pixel then coding the direction in which each subsequent pixel along that curve is located, or run-length encoding, where 0 may indicate background and 1 may indicate tissue.

Similar segmentation techniques may be used for other regions of interest. In addition, for a plurality of regions of medical interest 106 or regions not of medical interest 108, different techniques may be employed. For example, in lung cancer screening, there may be three regions. The lung field itself is of the highest medical interest and requires lossless compression or no compression. The anatomy outside of the lung field is of less medical interest but may provide useful context or background and may be compressed using a lossy compression method. The background is of no medical or contextual interest and may be discarded or compressed using a lossy compression method.

In one embodiment of the technique outlined in FIG. 9, prior knowledge may be used to automatically distinguish regions of medical interest 106 from regions not of medical interest 108. For example, in some instances the range of admissible values for data in the reconstructed volume may be relatively small compared to the range of numerical values available for the standard numerical representation. In mammography, the numerical values in the reconstruction are expected to lie between the value for fatty tissue (least attenuation) and the value for calcifications (highest attenuation). Smaller values than “fatty tissue” can only occur in the background or as an artifact of the reconstruction method, therefore the compression algorithm can explicitly use this prior knowledge and reduce the dynamic range of the data. Because the background is not of medical interest, data from this region may be discarded. Similarly, dynamic range management (DRM), thickness compensation, and other approaches can make compression more effective, since they reduce the dynamic range of the data by largely eliminating low-frequency content in the images. The eliminated low frequency content, if required, can be easily and very efficiently coded, at least approximately, for example, by using frequency information and the Shannon sampling theory or similar methods.

Additionally, in mammography, attenuation values corresponding to fatty and fibroglandular tissue are known, and most of the tissue in the breast is expected to lie somewhere in the range of these two values. Calcifications are the only structures within the imaged breast that are expected to assume values that lie outside of this interval. With this knowledge, three regions may be automatically distinguished in mammography tomosynthesis data: background, or regions with attenuation values below that of fatty tissue; breast tissue, or regions with attenuation values from that of fatty tissue to that of fibroglandular tissue; and calcifications, or regions with attenuation values greater than that of fibroglandular tissue. Markers that may be present in the image may also be assigned to the “calcifications” region. In this example, the breast tissue and calcifications regions may be of medical interest and therefore may be compressed using a lossless compression method or may not be compressed. These two regions of medical interest may be compressed and stored using different methods, depending on what method is determined to be best for each region. The background region may not be of medical interest and therefore may be discarded or compressed using a lossy compression method.

FIG. 10 illustrates compression process 114, a further embodiment of the present technique, in a flow chart. Compression process 114 is based on the observation that in the implementation of a simple backprojection reconstruction in Fourier space, the dc value is constant for all reconstructed slices, the low frequency content is slowly varying from slice to slice, and the high frequency content is more independent between slices. This observation may also apply to the projection images or to a reconstructed three-dimensional volume rendering. Therefore, different frequencies may be compressed differently in compression process 114. In addition, compression process 114 may apply not only to datasets obtained by simple backprojection reconstruction, but also by filtered backprojection type reconstructions, where the projection images are filtered prior to a simple backprojection operation. It should be noted that other reconstruction algorithms will generally have similar properties, and the resulting reconstructed datasets may thus be efficiently compressed using this approach. Some reconstruction algorithms may use non-linear techniques that replace the averaging in the simple backprojection step. However, the reconstructed datasets may still be very similar to datasets obtained with a simple backprojection step. Therefore, a suitable approximation of the dataset can be coded according to the present technique, while the differences to that approximation can be coded separately. Since these differences will typically be small, the compression can still be very effective. In addition, these observations may be true for a sequence of projection images acquired with tomosynthesis, and may therefore be used for efficient compression of the projection images as well as the reconstructed dataset.

In a step 118 the content in a given dataset 116 may be separated into low frequency content 120 and high frequency content 122. The low frequency content 120 may then be compressed in a step 124, for example, by encoding the content as a function of the height of the reconstructed slice or the location in the image sequence in a three-dimensional rendering. This low-frequency encoding may be accomplished, for example, by using simple sampling in conjunction with Shannon's sampling theory, wavelet decomposition, or similar methods. In addition, amplitude and phase may be encoded separately. Alternatively, the Fourier coefficient of a given frequency, as a function of height or slice number, is a linear combination of a small number of basis functions, where the basis functions are defined by the imaging geometry and the considered frequency. The reconstruction of a three-dimensional image of an object using Fourier transforms is described in U.S. Pat. No. 6,904,121, entitled “Fourier Based Method, Apparatus, and Medium for Optimal Reconstruction in Digital Tomosynthesis,” issued Jun. 7, 2005, which is herein incorporated by reference in its entirety for all purposes. Storing the coefficients in this linear combination, for each frequency, may be equivalent to a full representation of the reconstructed dataset. Compression in each frequency range may depend on the specific considered frequency, therefore different frequencies may have slightly different properties or basis functions.

High-frequency content is represented by a high frequency function and is therefore harder to compress by downsampling. However, the dynamic range for the high frequencies may be smaller, allowing for compression using dynamic range management in a step 126. Alternatively, in step 126, the high frequency content may be compressed using the coefficients of basis functions, as described above. Finally, in step 126, the high frequency content may not be compressed.

In a further embodiment of the present technique, a multi-scale compression approach may be used. In this multi-scale framework, the coarse scale information may be decompressed first, thus giving the reviewer a good overall impression of the data. More detail may be added incrementally to the images. This multi-scale approach may also be combined with aspects of the lossy/lossless compression as discussed in reference to FIG. 9, where image information in the regions that are not of medical interest are either decompressed only at a coarse resolution or are omitted from the compressed dataset. The regions that are not of medical interest may also be decompressed last.

FIG. 11 illustrates another embodiment of the present technique, designated as a process 128. In process 128, a dataset 130 may be classified in a step 132 to produce a classified dataset 134. This classification step 132 may be, for example, some type of image segmentation. In an embodiment of the present technique, the reconstructed dataset 130 may be constrained to a small number of discrete tissues or materials, such as, for example, air, fatty tissue, fibroglandular tissue, and calcifications. In such cases, the values of each voxel may be represented by only a few bits, for example two bits for the four-material decomposition. Once the voxels are classified in such a manner, compression algorithms using run-length encoding or specific basis functions, such as Haar wavelets, may be used to compress the dataset in a step 136 based on the individual voxel classifications. In a further embodiment of the present technique, lossy but non-discrete compression algorithms may be used to compress the dataset. In this case a suitable rounding operation may be required after decompression to correct for any errors introduced by the lossy representation.

In an alternative embodiment of process 128, the classification step 132 may involve approximating the dataset 130 as spheres of different sizes, each being homogeneous and consisting of a single material or tissue. For example, a collection of spheres, their materials, centers, and radii may be sufficient to represent the structure of the dataset 130. Ellipsoids, cubes, or other geometric shapes may also be used to represent structures. In addition, a combination of different shapes may be utilized. These geometric shapes may then be used as basis elements in the encoding step 136. The act of approximation may be automatic, semi-automatic, or manual.

In another embodiment of the present technique, illustrated in FIG. 12, perception optimized compression may be employed. That is, anything that is not visible to the human eye may not be stored. For example, in a process 138, a dataset 140 may be classified based on perceptibility in a step 142. That is, specific look-up tables or mappings that relate to just noticeable differences in the images may be used to classify changes from one image to the next that are not visible to the human eye. Instead of imposing a lossless compression scheme on the classified dataset 144, a near-lossless compression may be used in a step 146, wherein the gray level difference between the original and compressed images is less than a predefined threshold, usually 1, 2, or 3 at every pixel. The near-lossless compression step 146 may be used for the whole dataset, or regions of the images may be compressed with different degrees of fidelity for different regions.

Many of the compression processes described herein may also be used to compress multiple datasets, as illustrated in FIG. 13. In some instances, comparison to a contra-lateral organ or tissue as well as comparison to a previous year's exam may be important and extremely useful for the clinician in recognizing abnormalities. For example, in mammography there is generally a high degree of similarity between images of the same breast over time and between the left and the right breast for corresponding view angles. According to an embodiment of the present technique, multiple datasets 150 may be registered in a step 152. Registration may include, for example, translation, scaling, rotation, or any combination of these approaches. A compression algorithm may then be applied to the registered datasets 154 in a step 156. In certain embodiments, the geometric transformation or mapping that was performed in the registration step 152 may be coded as well. Due to the similarity between the registered datasets, simultaneous compression may be efficient. In one embodiment of the present technique, a first dataset is compressed independently and the small differences in the second dataset are then compressed. Simultaneous compression step 156 may also be performed with datasets 150 acquired using different modalities, such as ultrasound. In such cases, standard color video compression algorithms may be used, where each modality is assigned to a specific color channel. In addition, comparison to a dataset representing an anatomical atlas may be useful, for example, to distinguish medically relevant regions from other regions not of medical interest. Tomosynthesis datasets 150 may be registered to an atlas in step 152, and the registered datasets 154 may be compressed as differences to the atlas in step 156.

While the preceding techniques represent varying approaches to compressing tomosynthesis data, other approaches may also be employed. For example, in addition to or instead of the preceding approaches, standard image sequence or general data compression algorithms may be used, such as, for example, JPEG, MPEG, or ZIP.

Any method discussed here may be applied not only to the reconstructed datasets (e.g., in a slice-by-slice or other arrangement) or the radiographic projections themselves, but also to volume renderings or other visualizations of the dataset, where the sequence of images, upon decompression, may be optimized for review or further processing (e.g., with computer-aided detection or diagnosis). Furthermore, the set of images may be pre-processed, for example, filtered, and the pre-processed images compressed. Upon decompression, it may be fast and efficient to reconstruct the full volumetric dataset from this pre-processed dataset. Embodiments of the present technique may also be applied to a suitable review sequence, which may consist of a sequential display of different types of images. For example, the review sequence may contain the stack of slices of the reconstructed dataset followed by a suitable volume rendering. The full review sequence may be compressed using suitable methods as described herein.

The compression processes described herein may be used in conjunction with any compatible file formats, including, for example, DICOM images. These processes may also include appropriate encryption that can be used to protect unauthorized access to the image. Moreover, an error resilience strategy, such as, for example, packeting or error-correcting codes, may be used to ensure robustness in the compression encoding, that is, to allow complete or acceptable decoding from at least partially corrupted data. These concepts may be generally applicable where the data are to be remotely reviewed or stored on a non-restricted access server, or when data are transmitted over noisy communication channels.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for processing tomosynthesis imaging data comprising:
obtaining one or more tomosynthesis imaging datasets; and
compressing the one or more tomosynthesis imaging datasets using one or more compression algorithms.

2. The method of claim 1, wherein the tomosynthesis imaging dataset comprises at least one of a set of radiographic projection images, a stack of tomosynthesis slices, or a volume rendering of an imaged object.

3. The method of claim 1, comprising storing or transmitting the one or more compressed tomosynthesis imaging datasets.

4. The method of claim 1, wherein compressing the one or more tomosynthesis imaging datasets comprises compressing at least one dataset such that the dataset will be decompressed in an order designed to optimize its review or further processing.

5. The method of claim 1, wherein compressing the one or more tomosynthesis imaging datasets comprises encoding differences between a plurality of images or estimates of images.

6. The method of claim 1, wherein compressing the one or more tomosynthesis imaging datasets comprises differentially compressing two or more regions within the one or more tomosynthesis imaging datasets.

7. The method of claim 6, wherein differentially compressing two or more regions comprises locally varying at least one of compression characteristics or degree of fidelity to the uncompressed dataset.

8. The method of claim 1, wherein compressing the one or more tomosynthesis imaging datasets comprises differentially compressing the one or more tomosynthesis imaging datasets based on at least one of medical relevance, frequency content, geometric properties, or human perception.

9. The method of claim 1, wherein compressing the one or more tomosynthesis imaging datasets comprises differentially compressing the one or more tomosynthesis imaging datasets based on a limited number of discrete classifications applied to pixels, voxels, or regions of the one or more tomosynthesis imaging datasets.

10. The method of claim 1, wherein compressing the one or more tomosynthesis imaging datasets comprises differentially compressing the one or more tomosynthesis imaging datasets such that some tomosynthesis imaging data is more compressed than other tomosynthesis imaging data.

11. The method of claim 1, wherein compressing the one or more tomosynthesis imaging datasets comprises differentially compressing the one or more tomosynthesis imaging datasets such that some tomosynthesis imaging data is discarded while other tomosynthesis imaging data is retained.

12. The method of claim 1, comprising registering two or more tomosynthesis imaging datasets prior to compression.

13. The method of claim 1, wherein compressing the one or more tomosynthesis imaging datasets comprises compressing the one or more tomosynthesis imaging datasets and at least one related non-tomosynthesis dataset.

14. The method of claim 1, wherein compressing the one or more tomosynthesis imaging datasets comprises compressing a plurality of tomosynthesis imaging datasets corresponding to at least one of symmetrical body parts or datasets acquired at different times.

15. One or more tangible, machine readable media, comprising code executable to perform the acts of:
obtaining one or more tomosynthesis imaging datasets; and
compressing the one or more tomosynthesis imaging datasets using one or more compression algorithms.

16. The method of claim 15, wherein the tomosynthesis imaging dataset comprises at least one of a set of radiographic projection images, a stack of tomosynthesis slices, or a volume rendering of an imaged object.

17. The tangible, machine readable media of claim 15, further comprising code executable to perform the act of storing or transmitting the one or more compressed tomosynthesis imaging datasets.

18. The tangible, machine readable media of claim 15, wherein compressing the one or more tomosynthesis imaging datasets comprises encoding differences between a plurality of images or estimates of images.

19. The tangible, machine readable media of claim 15, wherein compressing the one or more tomosynthesis imaging datasets comprises differentially compressing two or more regions within the one or more tomosynthesis imaging datasets.

20. The tangible, machine readable media of claim 19, wherein differentially compressing two or more regions comprises locally varying at least one of compression characteristics or degree of fidelity to the uncompressed dataset.

21. The tangible, machine readable media of claim 15, wherein compressing the one or more tomosynthesis imaging datasets comprises differentially compressing the one or more tomosynthesis imaging datasets based on at least one of medical relevance, frequency content, geometric properties, or human perception.

22. The tangible, machine readable media of claim 15, wherein compressing the one or more tomosynthesis imaging datasets comprises differentially compressing the one or more tomosynthesis imaging datasets based on a limited number of discrete classifications applied to pixels, voxels, or regions of the one or more tomosynthesis imaging datasets.

23. The tangible, machine readable media of claim 15, wherein compressing the one or more tomosynthesis imaging datasets comprises differentially compressing the one or more tomosynthesis imaging datasets such that some tomosynthesis imaging data is more compressed than other tomosynthesis imaging data.

24. The tangible, machine readable media of claim 15, wherein compressing the one or more tomosynthesis imaging datasets comprises differentially compressing the one or more tomosynthesis imaging datasets such that some tomosynthesis imaging data is discarded while other tomosynthesis imaging data is retained.

25. The tangible, machine readable media of claim 15, further comprising code executable to perform the act of registering two or more tomosynthesis imaging datasets prior to compression.

26. The tangible, machine readable media of claim 15, wherein compressing the one or more tomosynthesis imaging datasets comprises compressing the one or more tomosynthesis imaging datasets and at least one related non-tomosynthesis dataset.

27. The tangible, machine readable media of claim 15, wherein compressing the one or more tomosynthesis imaging datasets comprises compressing a plurality of tomosynthesis imaging datasets corresponding to at least one of symmetrical body parts or datasets acquired at different times.

28. A tomosynthesis imaging data processing system comprising:
a computer capable of being operably coupled to at least one of a tomosynthesis image acquisition system or a tomosynthesis image storage system, the computer system configured to obtain one or more tomosynthesis imaging datasets and compress the one or more tomosynthesis imaging datasets using one or more compression algorithms.

29. The tomosynthesis imaging data processing system of claim 28, further comprising an operator workstation.

30. The tomosynthesis imaging data processing system of claim 28, wherein at least one of compression characteristics or degree of fidelity to the uncompressed dataset vary locally within the one or more compressed tomosynthesis imaging datasets.
